(19) United States
(12) Patent Application Publication
(10) Pub. No.: US 2005/0135780 A1
(43) Pub. Date: Jun. 23, 2005

(54) Apparatus and method for displaying moving picture in a portable terminal

(75) Inventors: Dae-Gyue Park, Buk-gu (KR); Hyun-Wook Cho, Buk-gu (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/988,618

(22) Filed: Nov. 16, 2004

(30) Foreign Application Priority Data
Dec. 22, 2003 (KR) 2003-94370

(51) Int. Cl. H04N 5/76; H04N 5/781

(52) U.S. Cl. 386/46; 386/125

(57) ABSTRACT

An apparatus and method for displaying a moving picture in a portable terminal capable of playback of moving pictures. The apparatus and method comprise inputting text to be displayed, storing it as a text file and selecting a moving picture file to be linked with the text file so as to set a text file to be replayed simultaneously with playback of the moving picture; executing a moving picture mode via operating keys when the portable terminal is in a stand-by mode, determining whether a moving picture playback mode is selected, and displaying a list of stored moving picture files when the moving picture playback mode is selected; and selecting a moving picture file to be replayed from the list of moving picture files so that the text file can be replayed and displayed simultaneously with playback of the moving picture.

### PRIORITY

This application claims the benefit under 35 U.S.C 119(a) of an application entitled “Method For Displaying Moving Picture In Portable Terminal” filed in the Korean Industrial Property Office on Dec. 22, 2003 and assigned Serial No. 2003-94370, the entire contents of which are incorporated herein by reference.

### BACKGROUND OF THE INVENTION

1. Field of the Invention

The present invention relates to a portable terminal. More particularly, the present invention relates to an apparatus and method for displaying a moving picture in a mobile terminal, by which a user can enjoy a moving picture in a mobile terminal by replaying data of the moving picture together with text data prepared by the user.

2. Description of the Related Art

Recently, technology in the field of portable terminals has been developed so as to empower the user with digital audio and video recording capabilities via a camera embedded in a portable terminal as well as simple voice communication and wireless internet service.

Additionally, due to the technological development of wireless internet, it is possible to enjoy moving picture content provided by Video On Demand (VOD) service.

VOD service is broadly classified into two types. The first type is a streaming service in which moving picture data corresponding to moving picture content are replayed while they are received from a VOD server by means of Realtime Transport Protocol (RTP). The second type is a download service in which moving picture data are downloaded as a full file by means of Hyper Text Transfer Protocol (HTTP), decoded and then replayed.

Such content for streaming and downloading are managed by a VOD server and are classified into content created by companies dealing in content for commercial purposes and content prepared by general users for the purpose of sending e-mail. When such moving picture content is replayed according to the Moving Picture Experts Group standards 4 (MPEG standards 4), text related to the content may be displayed at the same time.

Heretofore, in order to display text while moving picture content is replayed, the MPEG standards 4 may be used. In other words, text has to be inserted when encoding MPEG4 moving pictures. Therefore, there is a problem in that it is not possible to insert text into MPEG4 files that are previously encoded and formed. As a result, even if a user wants to display text related to a previously formed moving picture file, it is not possible to replay the moving picture simultaneously while displaying the text.

### SUMMARY OF THE INVENTION

Accordingly, the present invention has been made to solve the above-mentioned problem occurring in the prior art. An object of the present invention is to provide an apparatus and method for displaying a moving picture in a portable terminal. According to the method, a text file voluntarily prepared by a user is linked to a moving picture file that is previously encoded and formed so that the text file can be replayed while the moving picture is replayed at the same time.

In order to accomplish this object, there is provided an apparatus and method for displaying a moving picture in a portable terminal capable of playback of moving pictures. The apparatus and method include inputting text to be displayed, storing the input text as a text file and selecting a moving picture file to be linked with the text file to set a text file to be replayed simultaneously with playback of the moving picture; executing a moving picture mode by operating keys in a stand-by mode, determining whether a moving picture playback mode is selected or not, and displaying a list of stored moving picture files when the moving picture playback mode is selected; and selecting a moving picture file to be replayed from the list of moving picture files so that the text file can be replayed and displayed simultaneously with playback of the moving picture.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the structure of a portable terminal according to an embodiment of the present invention;

FIG. 2 is a schematic view illustrating the structure of a database for the management of moving picture files and text files according to an embodiment of the present invention;

FIG. 3 is a flow chart illustrating a method for displaying a moving picture in a portable terminal according to an embodiment of the present invention; and

FIG. 4 is a flow chart illustrating a method for setting a text file to be linked with a moving picture file according to an embodiment of the present invention.

### DETAILED DESCRIPTION OF THE PREFERRED EMBODIMENTS

Hereinafter, preferred embodiments of the present invention will be described with reference to the accompanying drawings.

In the following description of the present invention, a detailed description of known functions and configurations incorporated herein will be omitted for conciseness.

Further, specific definitions of the data format of a moving picture file and that of a text file are provided as examples, and it should be apparent to those skilled in the art that the present invention can be implemented without the specific examples.

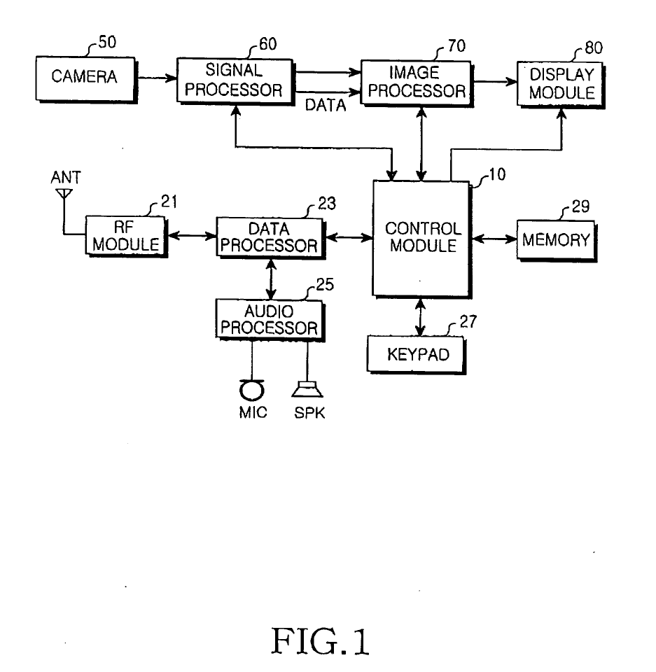

FIG. 1 is a block diagram illustrating the structure of a portable terminal according to an embodiment of the present invention.

Referring to FIG. 1, a radio frequency (RF) module 21 performs communication functions for the portable terminal. The RF module 21 includes an RF transmitter (not shown) for the up-conversion and amplification of the frequency of signals to be transmitted and a RF receiver (not shown) for performing low-noise amplification of received signals and down-conversion of the frequency thereof.

A data processor 23 includes a transmitter (not shown) for encoding and modulating the signals to be transmitted and a receiver (not shown) for demodulating and decoding the received signals. In other words, the data processor 23 may comprise a modulator/demodulator MODEM and a coder/decoder (CODEC).

An audio processor 25 performs the function for replaying received audio signals output from the data processor 23 to output to a speaker SPK, or for sending audio signals for transmission generated from a microphone MIC to the data processor 23.

A keypad 27 is equipped with keys for inputting number and letter information and various function keys for setting various functions. Additionally, according to an embodiment of the present invention, the keypad 27 may be equipped with a “menu” key, an “OK” key, function keys (for example a moving picture playback mode key and a text mode key) for executing the moving picture playback mode and the text mode, which are sub-menus of the moving picture mode, via the “menu” key and the “OK” key (or the like).

A memory module 29 may comprise program memory and data memory. In the program memory, programs are stored for controlling general actions of a portable terminal and programs for replaying a text file linked to a moving picture file when the moving picture is replayed according to an embodiment of the present invention. Additionally, the moving picture file and the text file are stored in the data memory, which further performs the function for temporarily storing data generated during execution of the above-mentioned programs.

A control module 10 controls overall actions of a portable terminal. Additionally, the control module 10 may include the data processor 23. According to an embodiment of the present invention, the control module 10 recognizes a text file linked to a moving picture file selected to be replayed in the moving picture playback mode and controls overall actions related with playback of the moving picture accompanied with playback of the text file. Further, the control module 10 causes the moving picture file to be linked to the predetermined text file according to an embodiment of the present invention. Further, the control module 10 permits the text file to be edited, corrected and deleted in a text edit mode according to an embodiment of the present invention.

A camera 50 performs photographing of image data and has a camera sensor for transforming optical signals obtained by photographing into electrical signals. The camera sensor may be assumed as a Charge-Coupled Device (CCD) sensor. A signal processor 60 transforms image signals output from the camera 50 into image signals. The signal processor 60 may be realized as a Digital Signal Processor (DSP).

An image processor 70 performs the function for generating screen data for displaying the image signals output from the signal processor 60. The image processor 70 transmits the received image signals or image data photographed by the camera 50 in a compatible form of a display module 80, under the control of the control module 10. Additionally, the image processor 70 compresses and expands the image data.

The display module 80 displays messages generated during execution of programs under the control of the control module 10. Additionally, the display module 80 displays image signals output from the image processor 70 on the screen in a camera-photographing mode, and displays user data output from the control module 10. Particularly, the display module 80 displays data of a moving picture file together with text data according to an embodiment of the present invention. Further, according to an embodiment of the present invention, the display module 80 displays a text file linked to a moving picture file and the moving picture file on the background screen as moving picture data and text data to be simultaneously replayed. More particularly, the display module 80 displays the text at any one position of the top, the bottom, the left and the right sides depending on the display position determined through the selection by a user. The display module 80 may be a liquid crystal display (LCD). In this case, the display module 80 may be equipped with a LCD controller, memory capable of storing image data, a LCD display device, etc. When the LCD is realized in the form of a touch screen, each of the keypad 27 and the LCD may act as an input section.

Hereinafter, the action of a portable terminal will be explained with reference to FIG. 1. When a user performs a dialing action through the keypad 27 and sets an outgoing mode, the control module 10 detects this, processes the dialed information received through the data processor 23, transforms it into RF signals through the RF module 21 and then output the RF signals. Next, when a partner generates response signals, the RF module 21 and the data processor 23 receive the signals. Then, the user can use the communication service upon the formation of a voice traffic channel through the audio processor 25. Additionally, in an incoming mode, the control module 10 detects the incoming mode through the data processor 23 and generates ring signals through the audio processor 25. When a user responses thereto, the control module 10 detects this and the user can use the communication service by the formation of a voice traffic channel through the audio processor 25. Although the outgoing and incoming modes as mentioned above were described as examples with regard to voice communication, it is possible to perform other data communication functions for the communication of packet data and image data. Further, when the stand-by mode or word communication mode is engaged, the control module 10 displays word data processed by the data processor 23 on the display module 80.

In addition, the above-described terminal can perform the action of displaying or sending an image screen obtained by photographing a person or the surroundings. First, the camera 50 may be mounted on a portable phone or connected to a desired external position. In other words, the camera 50 may be an external camera or an embedded camera. The camera 50 may use a Charge Coupled Device (CCD) sensor. The image photographed by the camera 50 is transformed into electrical signals by the internal CCD sensor and applied to the signal processor 60. Then, the signal processor 60 transforms the image signals into digital image data and outputs the data to the image processor 70.

In order to process and replay moving picture data, the above-described portable terminal can act as follows: first, in the stand-by mode, a user causes a text edit mode to be executed through the keypad 27. Then, the control module 10 stores a text file composed of texts (e.g., Hangul, English, special characters and numbers) corresponding to the keys inputted by the user in the memory 29.

After completing the text edit mode, the control module 10 permits the user to select a moving picture file to be replayed simultaneously with the text file. Then, the control module 10 recognizes the moving picture file selected through the keypad 27 and completes the step of setting the text file to be replayed simultaneously with playback of the moving picture file. Further, the linkage relationship between the moving picture file and the text file linked thereto is placed into the database and then stored in the memory 29.

Next, the control module 10 recognizes whether a moving picture playback mode is selected and whether the moving picture selected in the moving picture playback mode has a text file linked thereto. Then the control module 10 causes the text file to be replayed simultaneously with playback of the moving picture so that the moving picture can be displayed with the text on the display module 80.

The structure of the above-mentioned database for the management of the linkage relationship between the moving picture file and the text file will be explained hereinafter with reference to the accompanying drawings.

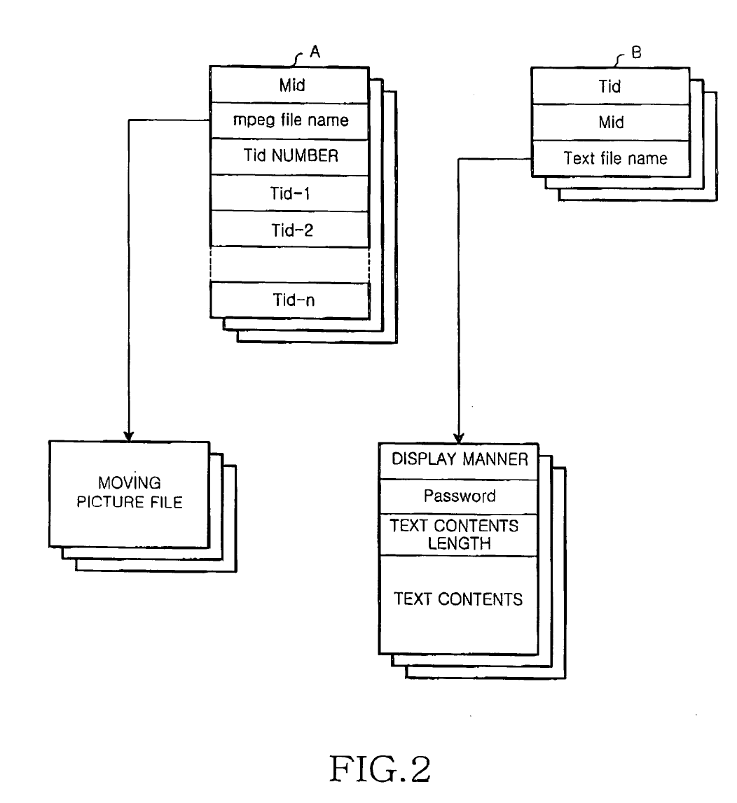

FIG. 2 is a schematic view illustrating the structure of database for the management of moving picture files and text files according to an embodiment of the present invention.

Referring to FIG. 2, a list A of moving picture files is made into the database in the format of header fields assuring the identity of a moving picture and representing the identity as moving picture data, an MPEG file name in which an actual moving picture is stored, the number of user text files linked to the moving picture file, i.e., Tid number, and text IDs Tid-1˜Tid-n for identifying a user texts linked to a moving picture file. More particularly, the text IDs exist for the number of user text files linked to the moving picture file, i.e., Tid number.

Additionally, a text list B including the information of the text file linked to the moving picture file is stored in the database in the format of ID Tid assuring the identity of the text, a moving picture ID Mid for determining between a user text and a moving picture, and a text file name in which actual text is stored. The text file name format will be explained in detail hereinafter.

As shown in FIG. 2, the text file name format includes the manner for displaying text simultaneously with playback of a moving picture (i.e. information about displaying the text on a screen at the top, the bottom, the left and the right sides simultaneously with playback of the moving picture, depending on the state set by the user), password information for placing restrictions on users with regard to display of the text, information about the length of the text to be displayed and information about text content to be displayed. More particularly, the information about the length of the text refers to the information used for synchronizing playback of the moving picture with displaying of the text after calculating the playback time of the moving picture file linked with the text. The text content refers to actual text content to be displayed, which are prepared by the user.

As described above, a moving picture file and a text file are separately stored in the memory 29. Then, the control module 10 causes playback of the moving picture file to be synchronized with the display of the text file by using the information made into database so that the moving picture file and the text file can be replayed at the same time and displayed on the display module 80.

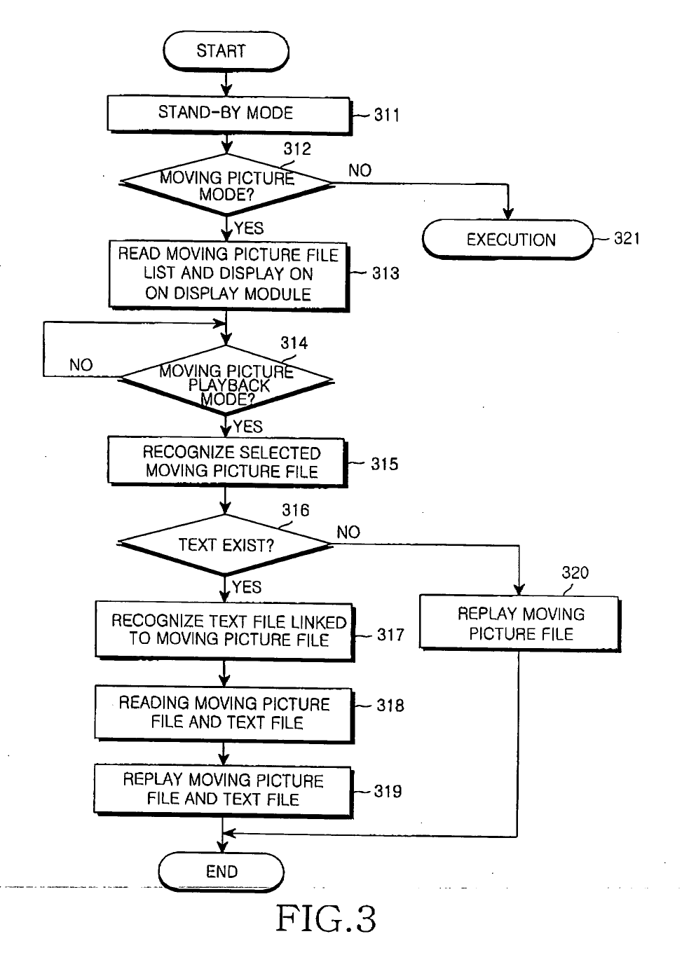

FIG. 3 is a flow chart illustrating a method for displaying a moving picture in a portable terminal according to an embodiment of the present invention.

Referring to FIG. 3, in a stand-by mode, in other words, in step 311 for waiting for a key input of a portable terminal, a moving picture mode is executed by operating keys in the keypad 27.

Then, the control module 10 determines whether a moving picture mode is selected in step 312. If the moving picture mode is not selected, the control module 10 advances to step 321 where another function other than the moving picture mode is executed. If the moving picture mode is selected, the control module 10 advances to step 313, reads a list of moving picture files stored in the memory 29 and displays the list on the display module 80.

When a user selects a moving picture file to be replayed from the list displayed on the display module 80 through an “OK” key, the control module 10 determines whether the selected moving picture file is in the moving picture playback mode in step 314. If the selected moving picture file is not in the moving picture playback mode in step 314, the control module returns to step 314.

After determining in step 314, that the selected moving picture file is in the moving picture file playback mode, the control module 10 recognizes the selected moving picture file through the “OK” key in step 315 and then advances to step 316 to determine whether any text file linked to the moving picture file is present.

Because the information about the moving picture file and the text file linked thereto is stored in the memory 29 in the form of a database, it is possible to determine whether any text file linked to the moving picture file is present based on the database, in step 317.

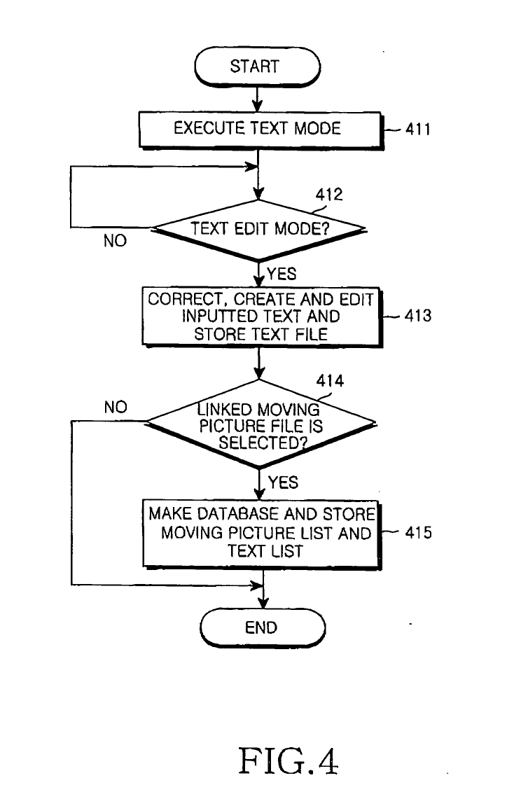

The database contains the information about linkage relationship between the moving picture file and the text file to be replayed simultaneously with playback of the moving picture file, the linkage relationship being set before executing the moving picture file playback mode. Such setting follows the procedure illustrated in FIG. 4.

FIG. 4 is a flow chart illustrating the step for setting a text file to be linked with a moving picture file according to an embodiment of the present invention. When the text mode is executed in step 412 by operating keys in the keypad 27 in step 411, the control module 10 determines whether a text edit mode is executed.

The control module 10 provides a text file containing text contents input through key handling of the keypad 27 and completes the text edit mode in step 413.

Next, the control module 10 determines whether a moving picture file to be linked to the text file stored in the memory 29 through the above-described steps is selected in step 414. When the moving picture file to be linked to the text file is selected, the control module 10 advances to step 415 to provide the text list B as shown in FIG. 2 into a database and stores the database in the memory 29.

By using the information of such database, the control module 10 determines whether any text file linked to the selected moving picture file is present, in step 316.

If a text file linked to the selected moving picture file is present based on the result obtained from step 316, the control module 10 recognizes the text file linked to the moving picture file through the database information in step 317. Then, the control module 10 advances to step 318 to read the moving picture file and the text file stored in the memory 29 through the database information, so that the moving picture file and the text file linked thereto can be replayed at the same time in step 319.

Then, the control module 10 displays the text file linked to the moving picture file by means of the display module 80. Particularly, the text contents of the text file displayed by the display module 80 are provided at any one position selected from the top, the bottom, the left and the right sides of the display module 80, according to the display manner information of the text list B as shown in FIG. 2 set by the user. More particularly, the text is displayed at a certain time calculated by considering the running time of the moving picture and the length of the text contents.

On the other hand, if no text file is linked to the selected moving picture file based on the result obtained from step 316, only the selected moving picture file is replayed and displayed in step 320.

While the invention has been shown and described with reference to certain preferred embodiments thereof, it should be understood by those skilled in the art that various changes in form and details may be made therein without departing from the spirit and scope of the invention. Particularly, while the operations and functions of the present invention have been described with reference to a conventional portable terminal as shown in FIG. 1, it is also possible to use a portable terminal further including multimedia chips for processing VOD data (recently appearing through technological development in the field of portable terminals). Therefore, the scope of the present invention is not limited to the above-described embodiments but defined by the appended claims and equivalents thereof.

As can be seen from the foregoing, according to the embodiments of the present invention, it is possible to insert text to a previously encoded and formed moving picture data so that the text data matched to the moving picture data can be replayed simultaneously with playback of the moving picture. Therefore, it is possible to enjoy a moving picture with text by using a previously formed moving picture data.

Further, it is possible to correct and edit text data voluntarily prepared by the user with ease during playback of the moving picture and thus the user's convenience and enjoyment are greatly increased.

1. A method for displaying a moving picture in a portable terminal capable of playback of moving pictures comprising the steps of:
inputting text to be displayed, storing the input text as a text file and selecting a moving picture file to be linked with the text file so as to set a text file to be replayed simultaneously with playback of the moving picture;
executing a moving picture mode via operating keys when the portable terminal is in a stand-by mode, determining whether a moving picture playback mode is selected, and displaying a list of stored moving picture files when the moving picture playback mode is selected; and
selecting a moving picture file to be replayed from the list of moving picture files so that the text file can be replayed and displayed simultaneously with playback of the moving picture.

2. A method for displaying a moving picture in a portable terminal capable of playback of moving pictures as claimed in claim 1, wherein the step for setting a text file to be replayed simultaneously with playback of the moving picture further comprises the steps of:
executing a text mode;
determining whether a text edit mode is selected, in the executed text mode, and inputting text when a text edit mode is selected;
storing the text as a file after completing input of the text;
selecting a moving picture file to be replayed together with the text file; and
providing a linkage relationship between the selected moving picture file and the text file in a database and storing the database.

3. A method for displaying a moving picture in a portable terminal capable of playback of moving pictures as claimed in claim 2, wherein the text of the text file can be created, edited, corrected and deleted in the text edit mode.

4. A method for displaying a moving picture in a portable terminal capable of playback of moving pictures as claimed in claim 1, wherein the list of the moving picture data in the database comprises header fields assuring the identity of a moving picture and representing the identity as moving picture data, a file name in which an actual moving picture is stored, number of user text files linked to a moving picture file, and text IDs for identifying a user text linked to a moving picture file.

5. A method for displaying a moving picture in a portable terminal capable of playback of moving pictures as claimed in claim 1, wherein the text of the text file can be turned on/off during playback of the moving picture and displayed on top, bottom, left and right sides of a screen during playback of the moving picture.

6. A method for displaying a moving picture in a portable terminal capable of playback of moving pictures as claimed in claim 1, wherein the list of text data in the database comprises an ID for assuring identity of the text, a moving picture ID for distinguishing between a user text and a moving picture, and information about a text file name in which actual text is stored.

7. A method for displaying a moving picture in a portable terminal capable of playback of moving pictures as claimed in claim 6, wherein the information about a text file name comprises information about the displaying of the text during playback of the moving picture, password information for placing restrictions on users with regard to the displaying of the text, information about length of the text content to be displayed, and information about the text to be displayed.

8. A method for displaying a moving picture in a portable terminal capable of playback of moving pictures as claimed in claim 6, wherein a playback time of the moving picture file is synchronized with that of the text file.

9. An apparatus for displaying a moving picture in a portable terminal capable of playback of moving pictures comprising:
a keypad adapted to input text to be displayed;
a memory adapted to store the input text as a text file;
a controller adapted to select a moving picture file to be linked with the text file so as to set a text file to be replayed simultaneously with playback of the moving picture, execute a moving picture mode via input keys when the portable terminal is in a stand-by mode, determining whether a moving picture playback mode is selected, display a list of stored moving picture files when the moving picture playback mode is selected, and select a moving picture file to be replayed from the list of moving picture files so that the text file can be replayed and displayed simultaneously with playback of the moving picture.

10. The apparatus of claim 9, wherein the controller is further adapted to execute a text mode, determine whether a text edit mode is selected, in the executed text mode, input text when a text edit mode is selected, store the text as a file after completing input of the text, select a moving picture file to be replayed together with the text file, provide a linkage relationship between the selected moving picture file and the text file in a database and store the database.

11. The apparatus of claim 10, wherein the text of the text file can be created, edited, corrected and deleted in the text edit mode.

12. The apparatus of claim 9, wherein the list of the moving picture data in the database comprises header fields assuring the identity of a moving picture and representing the identity as moving picture data, a file name in which an actual moving picture is stored, number of user text files linked to a moving picture file, and text IDs for identifying a user text linked to a moving picture file.

13. The apparatus of claim 9, wherein the text of the text file can be turned on/off during playback of the moving picture and is displayed on top, bottom, left and right sides of a screen during playback of the moving picture.

14. The apparatus of claim 9, wherein the list of text data in the database comprises an ID for assuring identity of the text, a moving picture ID for distinguishing between a user text and a moving picture, and information about a text file name in which actual text is stored.

15. The apparatus of claim 14, wherein the information about a text file name comprises information about the displaying of the text during playback of the moving picture, password information for placing restrictions on users with regard to the displaying of the text, information about length of the text content to be displayed, and information about the text to be displayed.

16. The apparatus of claim 14, wherein a playback time of the moving picture file is synchronized with that of the text file.
